(19) United States
(12) Patent Application Publication
(10) Pub. No.: US 2004/0138955 A1
(43) Pub. Date: Jul. 15, 2004

(54) Anti-fraud POS transaction system

(76) Inventors: Yuh-Shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/647,158

(22) Filed: Aug. 21, 2003

Related U.S. Application Data
(60) Provisional application No. 60/438,574, filed on Jan. 9, 2003.
(60) Provisional application No. 60/463,535, filed on Apr. 18, 2003.
(60) Provisional application No. 60/488,985, filed on Jul. 22, 2003.
(60) Provisional application No. 60/488,987, filed on Jul. 22, 2003.
(60) Provisional application No. 60/488,988, filed on Jul. 22, 2003.

(51) Int. Cl. G06F 17/60

(52) U.S. Cl. 705/17

(57) ABSTRACT

Anti-fraud measures are provided for a point-of-sale transaction using various consumer-oriented financial instruments such as credit cards, debit cards, and checks. Through a network, the payer is authenticated by a machine-readable official identification document and the availability of funds is verified by the payer's financial institution before the transaction is completed and the funds are immediately secured during the transaction. The entire transaction is securely verified and maintained in such a way that no party has a chance to alter any part of the transaction.

### CLAIM FOR PRIORITY

This application claims priority of U.S. provisional patent applications No. 60/438,574 filed on Jan. 9, 2003, No. 60/463,535 filed on Apr. 18, 2003, and Nos. 60/488,985, 60/488,987 and 60/488,988 filed on Jul. 22, 2003, which are hereby incorporated in this application.

### CROSS REFERENCE TO RELATED APPLICATIONS

Certain embodiments of the present invention may find utility in combination with the teachings of our copending applications filed concurrently herewith and hereby incorporated by reference in their entirety:

Anti-Fraud Remote Cash Transaction System (attorney docket 6443-102)

Anti-Fraud Document Transaction System (attorney docket 6443-103)

### TECHNICAL BACKGROUND

Checks, debit cards, and credit cards are the most commonly used payment instruments for a Point of Sale (“POS”) transaction. However, the financial industry is losing billions of dollars every year as a result of fraud occurring through these payment instruments. These losses are growing every year as more and more con artists have learned how to defraud our financial system. Payment fraud can be committed by: payees (e.g., merchants), payers (i.e., account holders), and third parties (i.e., con artists).

Checks are the most frequently used form of payment in the U.S. financial system. According to the statistics reported by the Federal Reserve, more than 40 billion checks were issued in the year 2001, which contributed to about 60% of all payments in the U.S. Due to the large volume of checks used in our daily life, most banks cannot afford to verify the signature on every check. Banks usually accept a check as long as the account information coded in the MICR format is a correct account and the dollar amount is not larger than a predetermined threshold, e.g., $3,000. As a result, even without stealing a check, a third party can easily fabricate a fake check by using commercially available check-printing software once the account information of a checking account is available.

For most cases, the signature and the physical appearance of the check are irrelevant as long as the dollar amount is not larger than the bank's predetermined threshold. A con artist can randomly pick any account number of a bank, print a check, fill in a dollar amount, sign a random name, and deposit it. Most likely, the con artist will get paid and the real checking account holder will not know what has happened until he/she receives the paid checks together with the monthly statement. An experienced con artist may fabricate fake checks against hundreds of checking accounts of a bank in a very short period of time, get paid, and disappear. There are more than twenty thousand financial institutions in the USA that provide checking accounts and are susceptible to this kind of fraud. Naturally, financial institutions are facing even higher risks as more people discover how easy it is to fool the financial system.

With today's advanced image editing technologies, a skillful con artist can easily duplicate a check or alter the payee name and dollar amount of a check. As a result, an expert may not be able to tell the difference when an altered check is presented to the bank, even if the dollar amount is larger than the predetermined threshold. There are quite a number of cases in which con artists have withdrawn hundreds of thousands of dollars from banks in a single altered check without being detected until too late. Consequently, banks are losing billions of dollars every year as a result of check fraud.

Furthermore, checks are not a preferred payment instrument at a point of sale. Even the true checking account holder can easily commit fraud by disputing a paid check, or leaving insufficient funds for an issued check after receiving the goods and services. Many merchants have suffered badly as a result of check fraud.

Some vendors establish (or subscribe to) a credit-history database, which stores the credit history of all persons. When a merchant receives a check from a customer, it examines the customer against this database to make sure that the customer has a good credit history before accepting the check. This approach has flaws because the merchant has no way of knowing whether the customer is really the account holder or not. As long as the customer does not have a bad record, even a fake check with a third-party's account number will be accepted. In addition, this kind of system may misjudge a person's credit when the economy turns sour. A person with a good credit history may not have any money in the bank when he/she has been unemployed for several months.

Although some security measures such as copy void pantograph, high-resolution micro-graphics, chemical preventions, watermarks, and reflective hollow strip have been theoretically effective in deterring check fraud by payees or third parties, the problem still persists. The cost of implementing and verifying these additional security measures is so high that most banks and their customers just cannot afford to do it. Besides, these methods cannot prevent the payer from committing fraud.

It has been proposed that check issuers should imprint on the checks some sort of specially encrypted information, which can be used by the drawee bank to validate the payees and the dollar amounts, but this technology is not readily applicable to consumer transactions. In fact, there has not been a comprehensive, economical and practical solution to preventing check fraud.

The “Check 21” (i.e., “Checks for the 21^{st} Century”) proposal, which is expected to pass the U.S. Congress during the summer of 2003, will worsen the fraud situation. The “Check 21” proposal permits banks to approve or deny a check payment based on the image of the check. Although the “Check 21” proposal can speed up the check clearance process and save the transportation cost of paper checks, it opens other doors to fraud.

Credit cards and debit cards were used for more than 20 billion payment transactions in the U.S. during the year 2001. They have become one of the most popular forms of payment in the U.S. financial system. Credit cards and debit cards are also exposed to high fraud risks. Since many merchants accept credit cards and debit cards over the phone or over the Internet based on the account numbers, a third party can easily commit fraud because the account numbers are hardly guarded by the cardholders. Moreover, stolen cards can even be used by thieves in many stores where the clerks are not experts in verifying the identification of a customer. The consumer protection laws further aggravate the situation because the maximum loss to a consumer as a result of a stolen credit card or debit card is limited to a very small amount. If the loss of a card is not a big issue to a consumer, the disclosure of a card number is certainly not a serious concern to the cardholder. In cases of a dispute where the dollar amount is not large, the consumer always has the advantage and either the merchant or the credit card or debit card company will normally take the loss.

As a result, cardholders can also easily commit fraud by denying the transactions (e.g., claiming loss or theft of the cards). In addition, merchants can easily commit fraud by fabricating fake transactions before going out of business. Billions of dollars are lost every year as a result of credit or debit card fraud.

To stay in business and make profits, credit card companies need to charge merchants 2% to 5% processing fees, and to charge cardholders very high interest rates (up to 20% or higher) and expensive fees. In fact, consumers are the ultimate victims of fraud because merchants also have to include the credit card or debit card processing fees and the losses caused by fraud into their cost of doing business. Consumers are actually absorbing all the losses due to fraud by paying higher prices for goods and services, higher interest and fees for the credit card or debit card usage.

Some merchants require a customer to enter a Personal Identification Number (“PIN”) into a point-of-sale device for verification purposes when the customer uses a debit card. The method is effective in preventing “debit cardholder fraud” to a certain degree at a point of sale. However, a cardholder can still claim loss of card and theft of the PIN. Furthermore, not everybody is willing to or able to remember his/her PIN, and will instead write it down where it can easily be compromised.

It has been proposed that a point-of-sale check transaction should be converted into another form of transaction such as an electronic funds transaction and the check is returned to the payer, but this merely opens a new door to fraud. A merchant can easily fabricate many fake transactions before going out of business. A thief can easily use check-printing software to fabricate fake checks with valid account numbers to conduct transactions. In fact, there are difficulties for a merchant or a bank to legally win a dispute if the checking account holder simply denies this kind of transaction later.

Many merchants require a payer to show a photo identification card at a point of sale. However, fake identification cards are easily available through the black market. Most merchants have no expertise to tell whether an identification card is a real one or not. Furthermore, in order to be courteous to a customer, most merchants will not demand that the customer turn over his/her identification card for a time-consuming verification process. It is also not practical to conduct a long verification process during peak business hours. As a result, a thief with a stolen checkbook, credit card or debit card can go on a shopping spree once a fake identification card is fabricated.

### SUMMARY OF THE INVENTION

The present invention relates generally to financial transactions. More specifically, the present invention provides anti-fraud measures for a network-based point-of-sale transaction using various consumer-oriented financial instruments such as credit cards, debit cards, and checks.

In this document, the terminology “network” or “networks” generally refers to a communication network or networks, which can be wireless or wired, private or public, or a combination of them, and includes the well-known Internet. Similarly, “bank” or “financial institution” generally refers to a financial service provider, either a bank or a non-bank, where financial services are provided; and “bank account” or “financial account” generally refers to an account in a financial institution, either a bank or a non-bank, where financial transactions are conducted through payment instruments such as checks, credit cards, debit cards, electronic fund transfers, etc.

One objective of the present invention is to reduce fraud committed by payees (e.g., merchants), payers (i.e., account holders) and/or third parties (i.e., con artists) during point-of-sale transactions, thereby reducing resultant financial losses to merchants, financial institutions (e.g., banks, credit card or debit card issuers, etc.), business organizations, and/or consumers (e.g., account holders).

According to one aspect of the present invention, the payer is authenticated and the availability of funds is verified by the payer's financial institution before the transaction is completed and the funds are immediately secured during the transaction so that the payer cannot deny the transaction later or otherwise commit payer fraud on the payee.

In accordance with another aspect of the present invention, a payee is prevented from entering into or modifying any transaction without obtaining express consent from a specified payer for a specific transaction amount that has been authenticated and verified by the payer's financial institution, so that the merchant cannot submit a fake or altered transaction or otherwise commit payee fraud.

In accordance with yet another aspect of the present invention, both the payee and the payer are authenticated and the details of the entire transaction are securely verified and maintained in such a way that no third party has a chance to alter any part of the transaction, thereby preventing third party fraud.

### BRIEF DESCRIPTION OF THE FIGURES

FIG. 1 illustrates a first set of embodiments for an anti-fraud, point-of-sale payment system in which payment is made by means of a check.

FIG. 2 (comprising FIG. 2A and FIG. 2B) is a flow chart for the process used in the system of FIG. 1.

FIG. 3 illustrates a second set of embodiments for an anti-fraud, point-of-sale payment system in which payment is made by means of a credit card or a debit card.

FIG. 4 (comprising FIG. 4A and FIG. 4B) is a flow chart for the process used in the system of FIG. 3.

### DETAILED DESCRIPTION OF CERTAIN PREFERRED EMBODIMENTS AND COMBINATIONS OF EMBODIMENTS

Overview

The present invention is part of a comprehensive suite of anti-fraud payment systems, which are applicable not only to such traditional payment instruments such as checks, credit cards and debit cards, but also to other transaction methodologies that have been or will be developed to support electronic commerce between parties that do not have established credit with one another, and potentially includes a number of embodiments to provide maximum flexibility so that these payment systems can satisfy many different needs, of both sophisticated and unsophisticated users. Accordingly, we will describe in detail only a few examples of certain preferred embodiments and combinations of the embodiments of the present invention; other inventive anti-fraud payment systems are disclosed in or will otherwise be apparent from the above-referenced copending applications.

As contemplated in the described embodiments, a point of sale (“POS”) device reads the payer's account information from the MICR line of a check, or the magnetic strip of a credit card, or a debit card in conventional fashion, and also reads the payer's identification information electronically from the machine-readable, embedded coded data of an official identification card such as a driver's license or a military ID card; however, it will be understood that in other embodiments, the required information could be read by more than one device and/or that some of the information could be entered manually. These pieces of information are sent to a Validation and Processing (“VPC”) system, which functions as an electronic intermediary between the payer and the payee, and compares these pieces of information against the information stored in the customer database of the payer's financial institution (i.e., a drawee bank or a credit or debit card issuer). If the payer's identification information matches the account holder information stored in the financial institutions, the POS transaction is effectively converted in real-time into an electronic funds transaction. The VPC system immediately transfers the transaction funds out from the payer's account through real-time networks, then into the payee's bank account through either real-time or non-real-time networks. As a result, there is no chance for fraud committed by the payer, the payee or the third parties at a point of sale. Check based Anti-Fraud, Point-of-Sale Payments

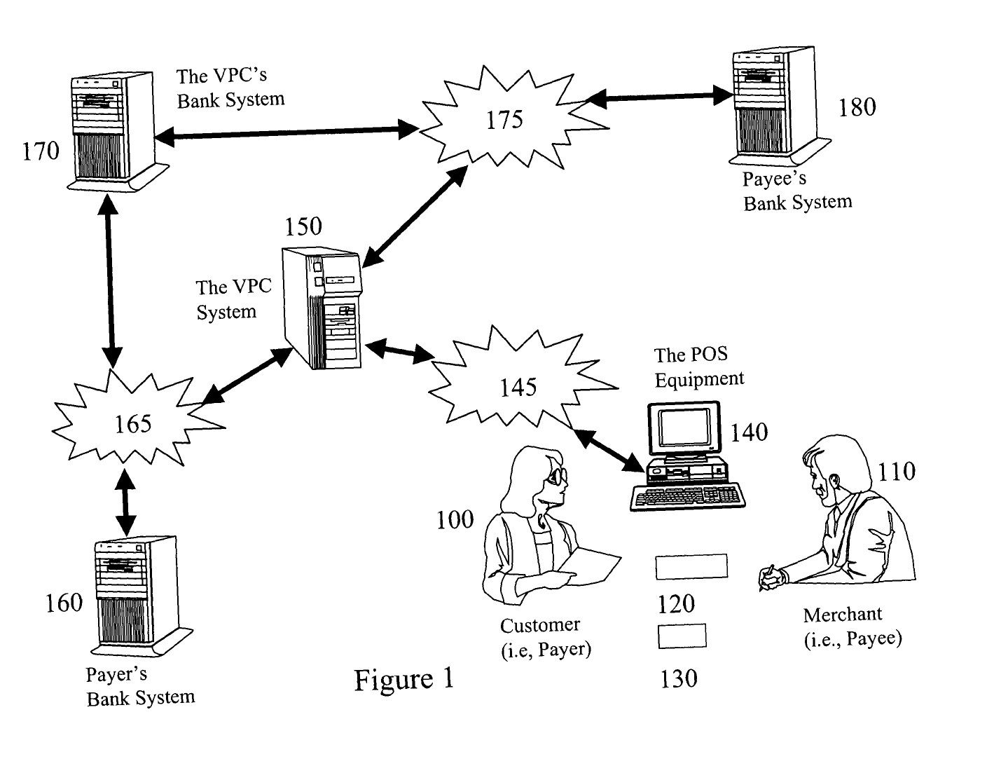

As illustrated in the system diagram of FIG. 1, in a first set of embodiments of the present invention, the payment instrument is a check 120 at a point of sale (“POS”). A POS device 140 reads the account information in the MICR line on a check of the payer (i.e., the checking account holder) at the point of sale, and the transaction information such as dollar amount, etc. is entered into the POS device. In addition, the POS device reads the machine-readable, embedded coded identification information stored in an official identification card 130 such as a driver's license or a military ID card of the payer for authentication purposes.

These pieces of information are sent to a Validation and Processing Center (“VPC”) 150 through a secure network 145. The VPC 150 has access to the account holder information, which is stored in the customer database 160 of the financial institution of the account holder. Although as currently contemplated the VPC 350 is independent of the other financial institutions, it could be established exclusively by or for one specific financial institution to provide services to the customers of that financial institution. The transaction will not be approved without an official identification card containing information that matches the account holder information of the account as coded in the MICR line on the check. If a business checking account is involved, the official identification card of the check signer can be used.

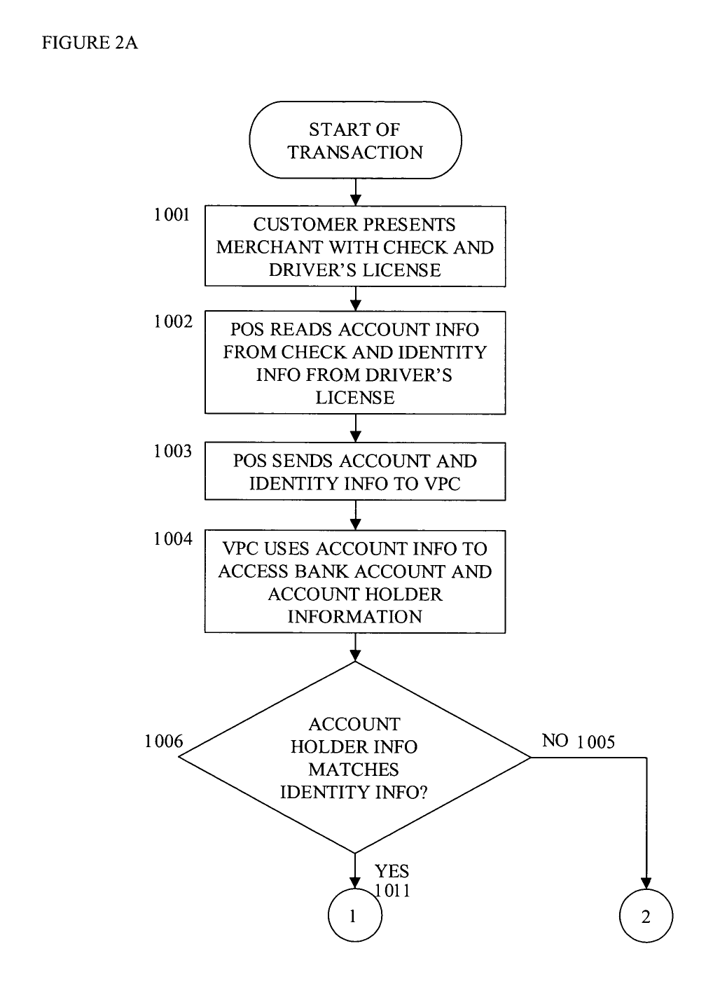

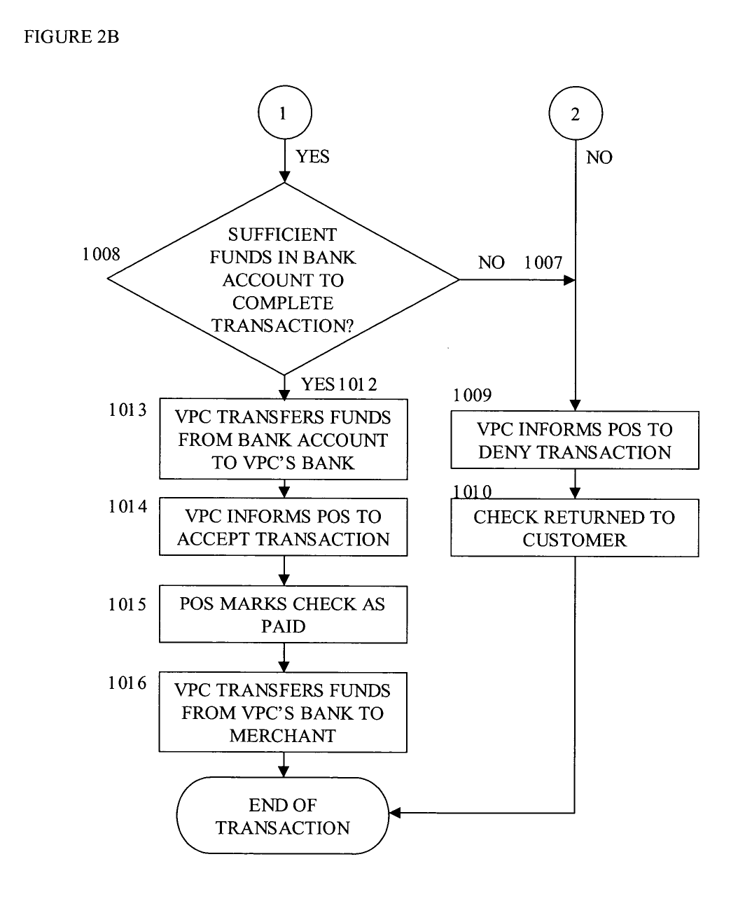

Reference should now be made to the flowchart of FIG. 2 in combination with the system diagram of FIG. 1, which together illustrate the operation of various embodiments of the system when a customer 100 intends to purchase goods and services from a merchant 110 at a point of sale. 140.

First (block 1001), the customer 100 gives the merchant a check 120 and his/her driver's license 130. Most people will not leave home without carrying a driver's license or some kind of official identification card. In fact, it is customary for a merchant to check a driver's license or some kind of identification card in a point-of-sale transaction. In general, a person immediately realizes when he/she loses his/her official identification card. Moreover, thieves do not want to fool around with an official identification card with a picture on it, especially when a device is now used to read the embedded information and to reveal the identity of the card owner.

Next (block 1002) the point-of-sale equipment 140 reads the account information of the customer 100, i.e., the payer, from the MICR line on the check 120 and the machine-readable, embedded coded identification information stored in the driver's license 130. Since it only takes a few seconds for a POS device to read an identification card, the customer identification process is fast, accurate, and courteous. In other embodiments, a radio frequency identification (“RFID”) device or other wireless data transmission device may be incorporated into the identification card; and the identification information is read from the identification card through an RFID reader or other wireless data receiver.

Then (block 1003), the data read from the check 120 and from the driver's license 130 are sent by the POS terminal 140 to the Validation and Process Center (“VPC”) system 150 through the secure network 145.

Then (block 1004), based on the received data from the POS terminal 140, the VPC system 150 accesses the account holder information stored in the customer database of the payer's bank system 160 through a real-time secure network 165.

If either the account holder's information obtained from the bank system 160 does not match the information obtained from the driver's license 130 (NO branch 1005 from decision block 1006), or if there are insufficient funds in the account for the transaction (NO branch 1007 from decision block 1008), the VPC system 150 informs the point of sale equipment 140 to deny the transaction (block 1009) and the check 120 is returned to the customer 100 (block 1010).

On the other hand, if the account holder's information obtained from the bank system 160 matches the information obtained from the driver's license 130 (YES branch 1011 from decision block 1006), and there are sufficient funds in the account for the transaction (YES branch 1012 from decision block 1008), the VPC system 150 immediately transfers the transaction funds from the payer's account of the bank system 160 to the VPC's account in the VPC's bank system 170 through a real-time secure network 165 (block 1013), and the VPC system 150 then informs the point of sale equipment 140 to complete the transaction (block 1014). The POS device cannot complete a transaction without this additional computer assisted matching of the account data with the identification card data. With this provision, a merchant is prohibited from committing any fraud even if the merchant knows the account information of a customer. A third party is excluded from the transaction because a third party cannot have the official identification card of the account holder.

Once the POS equipment 140 has been advised that the transaction has been accepted, the check 120 is clearly marked “PAID” (or other appropriate legend) so that this check 120 can no longer be circulated in the banking system as a negotiable instrument (block 1015). Either the customer 100 or the merchant 110 can keep the paid check as a tangible record of the transaction.

Concurrently with the physical marking of the check 120, the transaction funds are transferred from the VPC's bank system 170 to the merchant's bank system 180 through a secure network 175 (block 1016). Alternatively, the funds for the transaction may be sent to the merchant's VPC account or its associated bank account through an ATM Network, ACH or other similar real-time or non-real-time network depending on the commercial arrangement. The payment process is now completed. Those skilled in the art will realize that the secure networks 145, 165 and 175 can in practice be different secure paths over a common public network such as the Internet.

In an alternative embodiment of the present invention, the POS device reads the information from an identification card such as a driver's license as described above. In addition, a unique piece of personal information such as the social security number is required to enter into the POS device to support the authentication. A thief has no way to know the social security number of the owner of a stolen checkbook unless the thief is closely related to the account holder. The transaction will not be approved for an account without a matching official identification card such as a driver's license (a tangible object) and a matching piece of personal information such as a social security number (intangible personal knowledge) of the account holder. If a business checking account is involved, the official identification card and the personal information of an authorized signer can be used.

In general only a close friend or relative of the account holder will have access to the account holder's driver's license and checkbook, and will also know any required personal information. The chance for a unrelated thief to commit this kind of fraud without being detected is almost zero.

In another alternative embodiment of the present invention, the POS device has to read a piece of biometric information such as a fingerprint, which will be verified with the information stored in the customer database of the financial institution of the account holder, or in the identification card, or at the VPC. The transaction will not be approved for an account without a matching official identification card such as a driver's license (a tangible object), and a matching piece of biometric information such as a fingerprint (extremely private information) of the account holder. If a business checking account is involved, the official identification card and the biometric information of the authorized signer can be used.

Driver's license numbers and social security numbers are standard information stored in the customer database of financial institutions today, while biometric information is not stored yet. Due to privacy concerns and the high cost involved in the identification process, storing biometric information into the customer database of a financial institution may not be easily implemented and it may take some time to establish a biometric information database in the financial institution. As an interim measure, this biometric information can be captured at the POS device 140 and stored at the VPC 150 using suitable precautions to protect it from unauthorized access.

An alternative embodiment of the present invention may store the biometric information in the identification card. Once the account holder information obtained from the financial institution matches the information obtained from the identification card, the identification card is proven to be a valid one. Then, the biometric information stored in the identification card can be used to authenticate the identity of the payer.

Several possible levels of security can be applied during authentication of an account holder at a point of sale by using different embodiments of the present invention. A mixed version of security levels is possible for practical business purposes. For example, a merchant can use different levels of security based on the dollar amount, or the nature of goods and services involved in the transaction. Since the official identification card is electronically read by the POS device 140 and typically includes a number of security measures to prevent illegal copying or counterfeiting, the merchant cannot easily fabricate fake transactions simply based on the knowledge about the customers learned from prior transactions. Moreover, since third parties are excluded from the transactions, there is no chance for a third party to commit fraud. In accordance with the business practices of the parties involved, a trade-off among different security requirements may be chosen in order to provide the most cost-effective and customer-friendly solution. Such a trade-off should not be construed as a deviation from the present invention.

Some merchants use a self-service checkout stand for customers to check out the goods by themselves. Under such an environment, the POS device described above can be integrated with the self-service checkout equipment to facilitate the checkout and payment process directly handled by the customer in the POS environment.

In certain presently preferred embodiments of the present invention, at least the matching step 1006 is performed in a secure Validation and Processing Center (“VPC”) system 150 which is physically separate from both the POS device 140 and the financial institution system 160. The VPC system accesses the account holder information stored in the customer database of the financial institution through a secure network, and compares it against the information of the payer obtained from the POS device. However, those skilled in the art will realize that some or all of the VPC functions could be performed on the premises of the financial institution or the merchant, provided that appropriate security precautions are taken.

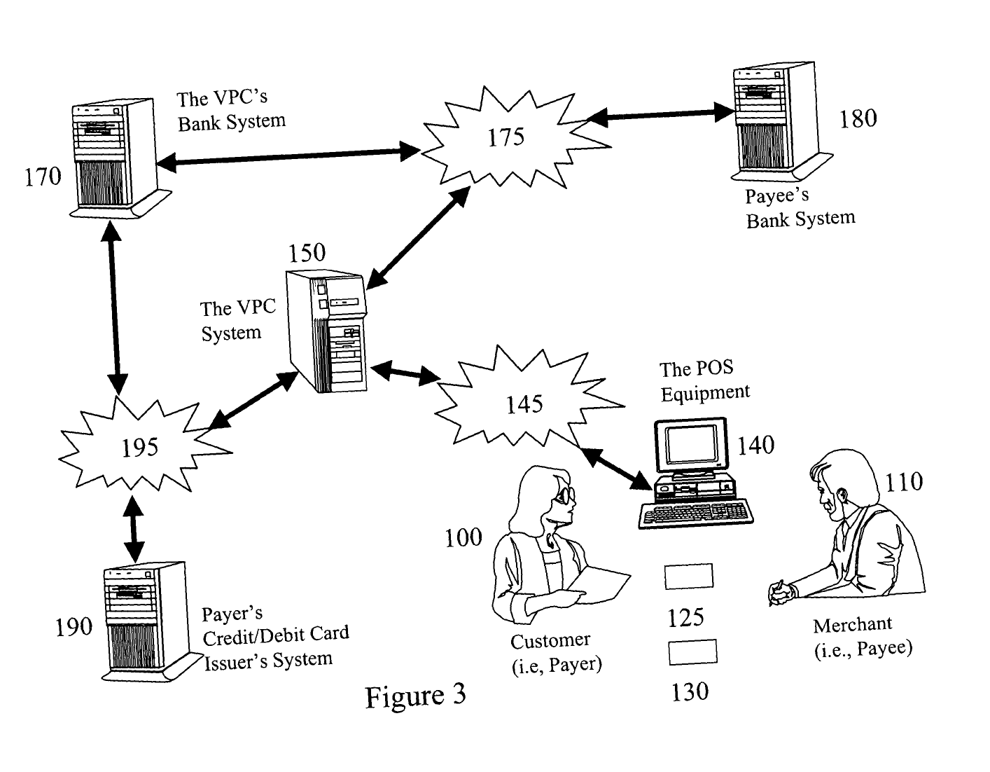

As illustrated in the system diagram of FIG. 3, in another set of embodiments of the present invention, a credit card or a debit card 130 is the payment instrument at the point of sale. A POS device 140 reads the account information which is electronically embodied in the credit card or a debit card (for example, by means of a magnetic stripe or an integrated semiconductor memory). The transaction information such as dollar amount, etc., can be entered into the POS device 140 as usual. In addition, the POS device reads the machine-readable, embedded coded identification information stored in an official identification card 125 such as a driver's license or a military ID card of the payer for authentication purposes.

These pieces of information are sent to the Validation and Processing Center (“VPC”) 150 through the secure network 145 for authentication purposes. These pieces of information are checked against the account holder's information stored in the customer database 190 of the card issuer. If it is a match, the transaction funds are secured and the transaction will proceed as usual. If it is a mismatch, the transaction is denied. The POS device cannot conduct a transaction without a credit card or a debit card and a matching official identification card of the payer.

Due to the competition among different credit card or debit card issuers, most people carry multiple credit cards or debit cards. As a result, a consumer is less concerned when he/she loses a credit card or a debit card, especially when the consumer protection law has limited the maximum liability to a cardholder when he/she loses a card. However, a consumer is very concerned when he/she loses the official identification card such as a driver's license. Thus, the opportunity for a thief to steal both a credit card or a debit card and an official identification card without being reported is extremely low. Furthermore, thieves do not want to fool around with an official identification card with a picture on it, especially since it is now possible for a simple electronic device to recover any electronically embedded information and verify the identity of the true cardholder.

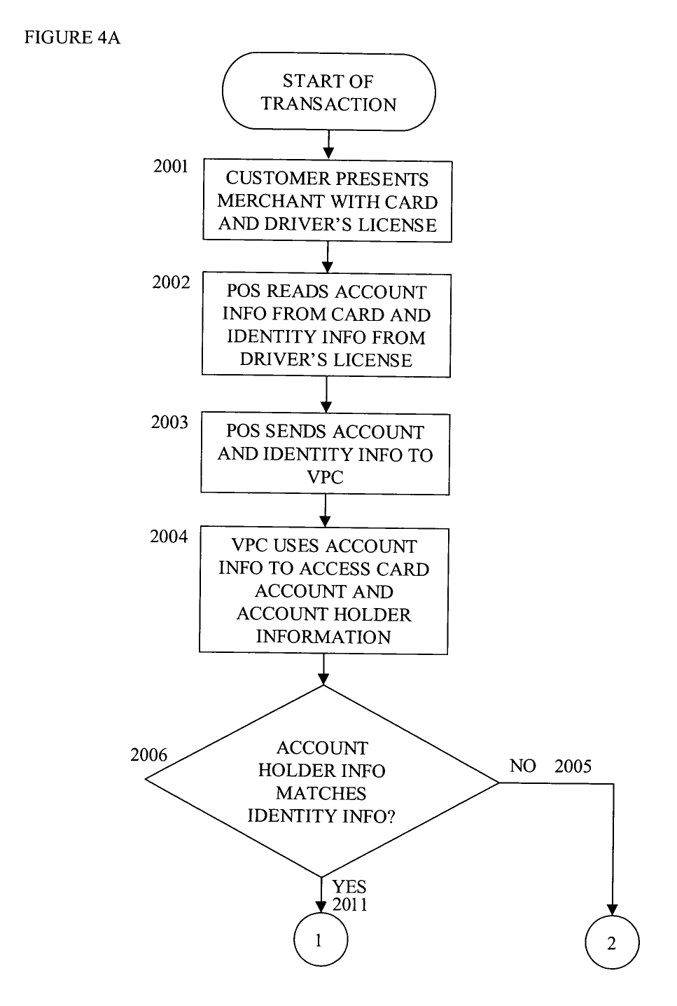

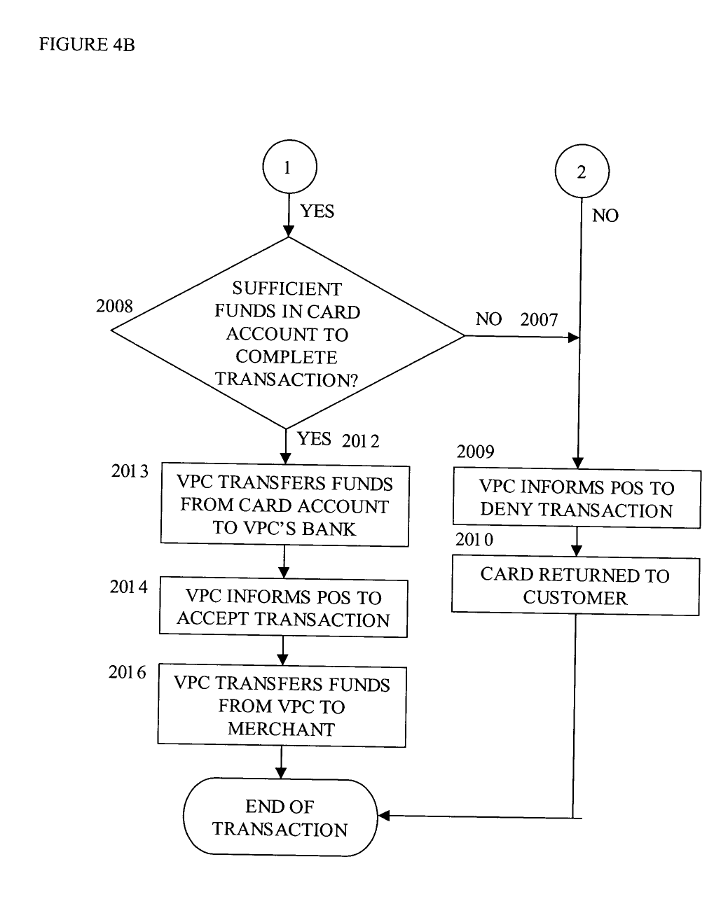

Reference should now be made to the flowchart of FIG. 4 in combination with the system diagram of FIG. 3, which together illustrate the operation of the system when a customer 100 intends to purchase goods and services from a merchant 110 at a point of sale, 140, using a credit or debit card 125.

First (block 2001), the customer 100 gives the merchant a credit or debit card 125 and his/her driver's license 130. Most people will not leave home without carrying a driver's license or some kind of official identification card. In fact, it is customary for a merchant to check a driver's license or some kind of identification card in a point-of-sale transaction. In general, a person immediately realizes when he/she loses his/her official identification card. Moreover, thieves do not want to fool around with an official identification card with a picture on it, especially when a device is now used to read the embedded information and to reveal the identity of the card owner.

Next (block 2002), the point-of-sale equipment 140 reads the account information of the customer 100, i.e., the payer, from the card 125 and the machine-readable, embedded coded identification information stored in the driver's license 130. Since it only takes a few seconds for a POS device to read an identification card, the customer identification process is fast, accurate, and courteous.

Then (block 2003), the data read from the card 125 and from the driver's license 130 are sent by the POS terminal 140 to the Validation and Process Center (“VPC”) system 150 through the secure network 145.

Then (block 2004), based on the received data from the POS terminal 140, the VPC system 150 accesses the account holder information stored in the customer database of the card issuer's system 190 through a real-time secure network 195.

If either the card holder's information obtained from the card issuer's system 190 does not match the information obtained from the driver's license 130 (NO branch 2005 from decision block 2006), or if there are insufficient funds in the account for the transaction (NO branch 2007 from decision block 2008), the VPC system 150 informs the point of sale equipment 140 to deny the transaction (block 2009) and the card 125 is returned to the customer 100 (block 2010).

On the other hand, if the account holder's information obtained from the card issuer's system 190 matches the information obtained from the driver's license 130 (YES branch 2011 from decision block 2006), and there are sufficient funds in the account for the transaction (YES branch 2012 from decision block 2008), the VPC system 150 immediately transfers the transaction funds from the card issuer's system 190 to the VPC's account in the VPC's bank system 170 through a real-time secure network 195 (block 2013), and the VPC system 150 then informs the point of sale equipment 140 to complete the transaction (block 2014). The POS device cannot complete a transaction without this additional computer assisted matching of the account data with the identification card data. With this provision, a merchant is prohibited from committing any fraud even if the merchant knows the account information of a customer. A third party is excluded from the transaction because a third party cannot have the official identification card of the account holder.

The transaction funds are transferred from the VPC's bank system 170 to the merchant's bank system 180 through a secure network 175 (block 2016). Alternatively, the funds for the transaction may be sent to the merchant's VPC account or its associated bank account through an ATM Network, ACH or other similar real-time or non-real-time network depending on the commercial arrangement. The payment process is now completed.

Those skilled in the art will realize that the secure networks 145, 175 and 195 can in practice be different secure paths over a common public network such as the Internet. Those skilled in the art will also realize it is possible to directly integrate VPC system 150 into existing ATM, credit card, or debit card networks. Moreover, due to the similarity between the VPC systems of the present invention and corresponding systems described in the referenced related applications, it is contemplated that they may be integrated into a single system that provides a universal anti-fraud payment system that can be used for all types of transactions.

Similar to a POS transaction through a check as described above, in an alternative embodiment of the present invention, an official identification card and a piece of personal information (e.g., social security number, etc.) not on the identification card must both be used to complete a POS transaction through a credit card or a debit card.

Similarly, in another alternative embodiment of the present invention, an official identification card and a piece of biometric information supplied by the account holder must both be used to complete a POS transaction through a credit card or a debit card. The matching biometric information may be stored in the card issuer's data base or at the VPC.

Alternatively, any required biometric information may be stored in the identification card. Once the card holder information obtained from the card issuer has been matched to the information obtained from the identification card, the identification card is considered valid for the current card transaction. Then, the biometric information stored in the valid identification card can be used to authenticate the identity of the customer.

Similar to the case of a check-based point-of-sale transaction, several possible levels of security can be applied during authentication of a cardholder at a point of sale by using different embodiments of the present invention. A trade-off among different security requirements may be chosen in order to provide the most cost-effective and customer-friendly solution, and should not be construed as a deviation from the present invention.

Similarly, the card-based POS device can be integrated with self-service checkout equipment to facilitate the checkout and payment process directly handled by the customer in the POS environment.

The embodiments described in this document can be assembled to form a variety of applications based on the need. Workers skilled in the art and technology to which this invention pertains will appreciate that other alterations and changes in the described structure may be practiced without meaningfully departing from the principal, spirit and scope of this invention.

1. A method for verification and processing of a point of sale (“POS”) financial transaction involving a payer's account at a financial institution, comprising:
identifying the financial institution and the specific account at that institution based on the financial instrument used in the transaction,
reading embedded identification information by the POS device from a machine-readable identification card in the possession of the purported payer;
sending the payer's identification information, the specified financial institution and account information, and the transaction details read by the POS device to a Validation and Processing Center (“VPC”) system through networks;
accessing by the VPC system through networks to a remote database maintained by the financial institution containing account available balance information and account holder information for said specific account;
verifying that the embedded identification information read by the POS device matches the account holder information for the identified account stored in the remote database;
verifying that the identified account has sufficient funds to cover a transaction amount specified by the payer; and
if the verification of both the identity of the payer and the amount of the transaction is successful, causing the specified amount to be electronically transferred from the specified payer's account to a designated payee.

2. The method of claim 1 further comprising:
prompting the payer to input into the POS device an additional item of personal information not embedded in the identification card but stored in the remote database of the financial institution, and
verifying that the additional personal information input by the payer matches the personal information stored in the remote database.

3. The method of claim 2, wherein the personal information input by the payer includes at least part of a social security number.

4. The method of claim 2, wherein the personal information input by the payer includes at least biometric information.

5. The method of claim 4, wherein the biometric information input by the payer includes at least a fingerprint.

6. The method of claim 1 further comprising:
prompting the payer to input into the POS device an additional item of personal information embedded in the identification card but not stored in the remote database of the financial institution, and
verifying that the additional personal information input by the payer matches the personal information embedded in the identification card.

7. The method of claim 6, wherein the additional personal information input by the payer includes at least a personal identification number.

8. The method of claim 6, wherein the additional personal information input by the payer includes at least biometric information.

9. The method of claim 8, wherein the biometric information input by the payer includes at least a fingerprint.

10. The method of claim 1 wherein the transaction details sent to the VPC system include the transaction amount, and the payee's financial account information.

11. The method of claim 1 wherein the completion of the funds transfer from the specified payer's account to a designated payee further comprises:
transferring the specified payment amount from the payer's account to the VPC's bank system; and
transferring the payment amount from the VPC's bank system to the payee's financial account.

12. The method of claim 1 wherein the VPC system secures the funds for the transaction against the potential payer fraud.

13. The method of claim 1 wherein:
the transaction is based on a financial instrument in the form of a check drawn on the specified financial institution; and
the account and financial institution information is obtained by reading encoded information imprinted on the check.

14. The method of claim 13, wherein the financial instrument is marked as non-negotiable after the specified payment amount has been transferred from the specified payer's account.

15. The method of claim 13, wherein a magnetic ink character recognition device is incorporated into the POS device to read the account and financial institution information imprinted on the check.

16. The method of claim 1 wherein:
the transaction is based on a regular credit card and/or debit card issued by a specified financial institution; and
the account and financial institution information is embedded in the card in a machine readable format.

17. The method of claim 1 wherein
a card reader is used to read the account and financial institution information contained in the card, and
said information is embedded in the card in a machine readable format.

18. The method of claim 17, wherein a magnetic card reader is used to read the account and financial institution information contained in a magnetic strip of the card.

19. The method of claim 1, wherein:
the POS device is incorporated into a self-service checkout stand whereby customers may check out the goods and/or services by themselves.

20. The method of claim 1, wherein:
the VPC system is established exclusively for one financial institution to provide services to the customers of the financial institution.

21. The method of claim 1, wherein:
a wireless data transmission device is incorporated into the identification card; and
a wireless data receiver is incorporated into the POS device to read the machine-readable identification information of the identification card.
